(19) United States
(12) Patent Application Publication
(10) Pub. No.: US 2014/0059999 A1
(43) Pub. Date: Mar. 6, 2014

(54) RAKE ASSEMBLY WITH INTEGRAL DEBRIS COLLECTOR

(71) Applicant: Bradley Richard Harris, Baton Rouge, LA (US)

(72) Inventor: Bradley Richard Harris, Baton Rouge, LA (US)

(21) Appl. No.: 14/018,815

(22) Filed: Sep. 5, 2013

Related U.S. Application Data
(60) Provisional application No. 61/743,498, filed on Sep. 6, 2012.

(51) Int. Cl. A01D 7/10

(52) U.S. Cl. CPC A01D 7/10
USPC 56/400.11

(57) ABSTRACT

The present invention includes a rectangular base plate having a forward end, a rearward end, an upper surface, and having a set of teeth extending horizontally from the forward end of the plate. The teeth rake debris from lawn onto the upper surface of the plate. A handle having a U-shaped yoke is pivotally attached at the sides of the forward end of the plate and extend upwardly from the plate, forming an opening for receiving the debris that is raked onto the plate. A flexible collection bag having an open front end and an enclosed rear end is positioned on the plate. The front end of the bag is secured around the opening formed by the plate and the yoke of the handle, for collecting the debris that is received through the opening.

### BACKGROUND OF THE INVENTION

1. Field of the Invention

The invention relates to an improved rake assembly. More particularly, the present invention pertains to a rake for gathering and removing debris from a lawn, field, garden or other surface.

2. Brief Description of the Prior Art

Rakes are well known. Further, use of rakes is well known to assist in gathering and/or consolidating cut grass, fallen leaves, weeds, paper, plastic trash and/or other materials (collectively referred to herein as “debris”) into piles. Once consolidated into piles, such debris is frequently transferred to either a central disposal location, or desirable mulch or trash depositories.

Conventional rakes have remained relatively unchanged for many years. Conventional rakes typically include a lateral head (usually, approximately 1 foot wide) having a series of rigid metallic teeth or tines, widely spaced, and extending from said lateral head (usually about 3 inches). Further, said conventional rakes typically have an extended handle for pulling said rake over the ground or other surface in order to contact and gather debris. By way of illustration, but not limitation, a conventional rake can be passed over a lawn of fallen leaves to gather and form said leaves into a pile for transfer and removal/disposal.

One particular type of conventional rake is commonly referred to as a “grass rake”. A conventional grass rake typically includes a lateral head (usually about 1½ feet wide) having a series of fanned flexible teeth members, closely spaced, with curved and downwardly-facing tips. Further, said conventional grass rakes typically have an extended handle for pulling said rakes over the ground or other surface in order to contact and collect debris. By way of illustration, but not limitation, a conventional grass rake can be passed over a lawn of recently mowed grass to gather and form said cut grass into pile(s) for transfer and removal/disposal.

In one variation, a grass rake has a head that can be selectively repositioned; the rake can be utilized in typical fashion by pulling to rake over grass, and then converted to a “push rake” by turning the head over so that the teeth extend upwardly. Said overturned rake further includes a pair of side walls extending a short distance above and along a fan-shaped head of the rake. The over-turned curved teeth can be used to push the grass forward of the teeth into a pile; any grass that travels over said teeth are confined on the upper fan by the short walls. Said head can then tipped or overturned in order to form grass into a pile.

Another variation involves a separate bagging device that is utilized with a conventional rake or broom for transferring a pile of debris into said bagging device for subsequent removal. Said bagging device is separate from the rake assembly.

All prior art rakes are utilized to first rake debris into piles; thereafter, said piled debris must be further transferred into a bagger, cart or other collector for removal and/or disposal. As such, a user is required to bend down to lawn level in order to transfer a pile of debris for removal. Such bending is not possible by some disabled users, and can also cause stress, strain and pain to healthy users.

In view of the foregoing, it is an object of the present invention to provide a rake assembly that does not require an operator to bend or stoop to collect and remove debris from a lawn or other surface.

It is another object of the present invention to provide a rake assembly that integrally collects debris from a lawn or other surface for removal to a desired depository.

It is another object to provide a rake assembly with an integral debris collector that is relatively inexpensive to manufacture, and that is reliable and durable in use.

### SUMMARY OF THE INVENTION

The present invention comprises a rake assembly for gathering and removing debris from a lawn or other surface. In a preferred embodiment, the rake assembly of the present invention includes a substantially planar base plate having a forward end, a rearward end, an upper surface, and a plurality of teeth or tines extending outward from the forward end of said plate. As said plate is moved in a direction that is substantially parallel to a lawn or other surface, the horizontal teeth direct debris onto the upper surface of said plate.

A handle having a substantially U-shaped yoke is pivotally attached to said plate, typically near the sides of the forward end of the plate, and extends upwardly from said plate. Said U-shaped yolk defines an opening for receiving debris that is raked or otherwise directed onto said plate. Said handle further comprises an elongated shaft extending from the yoke for maneuvering and manipulating the rake along the lawn or other surface being raked.

A flexible collection bag having a front end, a rear end, and a bottom portion is positioned horizontally on the upper surface of the plate. In the preferred embodiment, said bottom portion has a width extending substantially to the sides of the plate and a length extending from the forward end to the rearward end of said plate. Further, in the preferred embodiment, said bag has side portions extending upwardly from the lower portion and a generally rectangular top portion enclosing the side portions. The rear end of said collection bag is enclosed, and the front end of the bag is secured around the opening formed by said plate and said yoke of the handle, for collecting the debris that is received through such opening.

During use, the angle of the extended opening of said bag varies depending upon the angle of the handle and whether the rake is pushed or pulled along the lawn or other surface being raked. After said collection bag has been filled with debris, the rake assembly of the present invention can be conveniently carried or dragged to a desired depository, where said debris can be emptied from the bag into a lawn bag, trash bin or other receptacle.

### BRIEF DESCRIPTION OF DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. Further, dimensions, materials and part names are provided for illustration purposes only and not limitation.

FIG. 1 depicts a perspective view of a rake assembly of the present invention with a handle member in a substantially upright position.

FIG. 2 depicts an exploded view of a rake assembly of the present invention.

FIG. 3 depicts a perspective view of a rake assembly of the present invention with a handle member in a tilted position.

FIG. 4 depicts a perspective view of a rake assembly of the present invention being used to collect leaves and/or other debris.

FIG. 5 depicts a perspective view of the rake assembly of the present invention being used to transfer leaves and/or other debris.

### DETAILED DESCRIPTION OF A PREFERRED EMBODIMENT

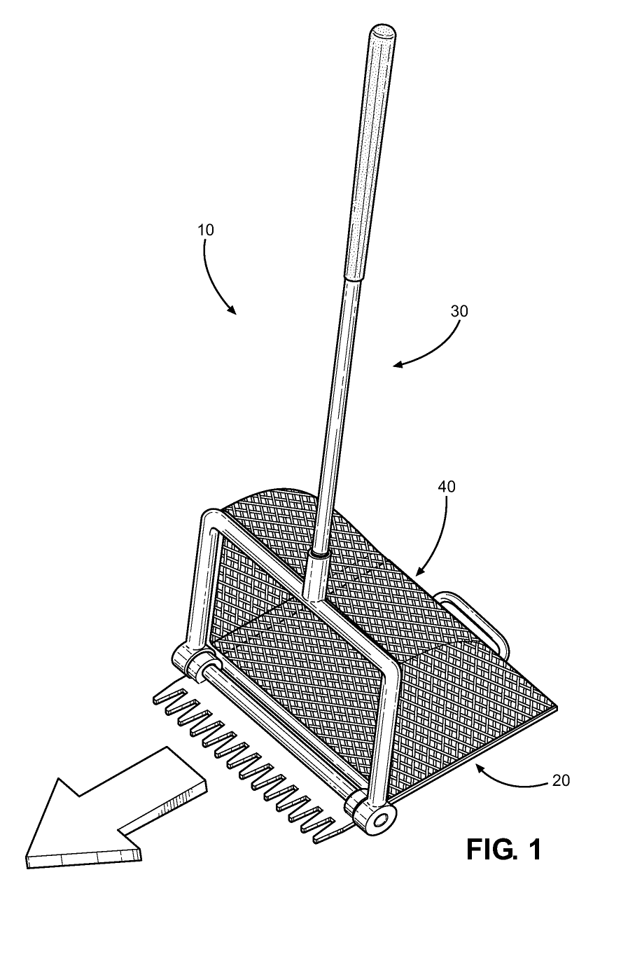

FIG. 1 depicts a front perspective view of a preferred embodiment of rake assembly 10 of the present invention. Said rake assembly 10 comprises base plate 20, handle member 30, and collection bag 40. As depicted in FIG. 1, handle member 30 comprises an elongate rigid member that can be used to move and/or manipulate rake assembly 10, including generally in the direction shown in FIG. 1.

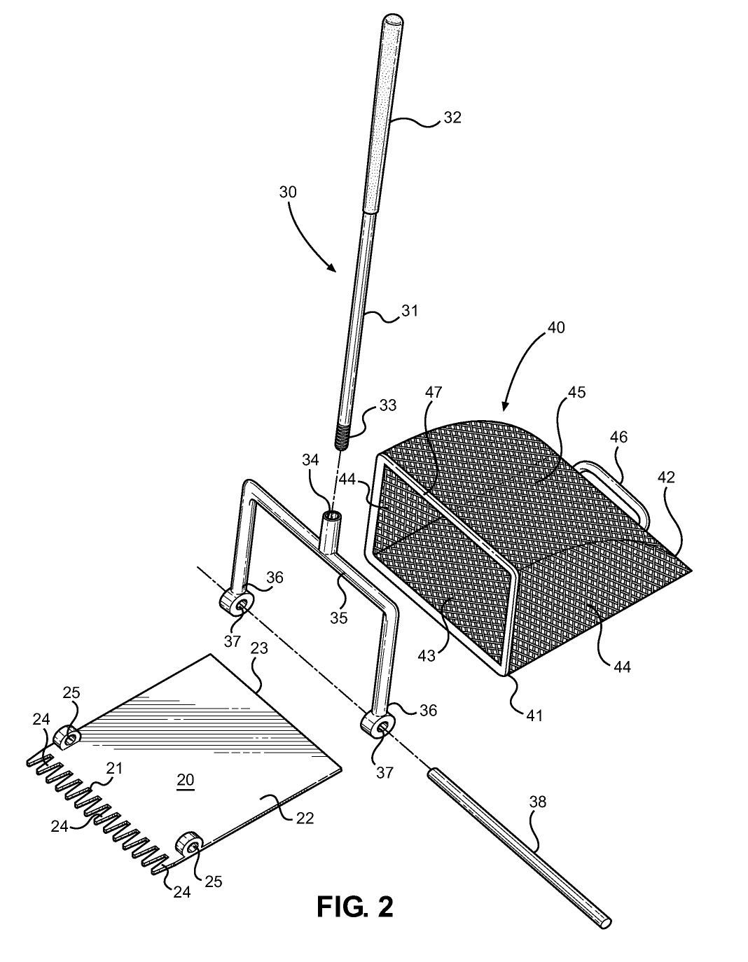

FIG. 2 depicts an exploded view of a rake assembly 10 of the present invention. Referring to FIG. 2, base plate 20 is depicted as a substantially planar and rectangular plate having a forward end 21, a rearward end 23, an upper surface 22, and having a plurality of teeth 24 extending substantially horizontally from the forward end of said plate 20. Although plate 20 is depicted in FIG. 2 as having a substantially rectangular shape, it is to be observed that said plate 20 can be formed in a variety of shapes (circular, semi-circular, oval, triangular or other beneficial shape).

Still referring to FIG. 2, it is further to be observed that plate member 20 can be fabricated from wood or metal, or stamped or molded from plastic or composite material. In a preferred embodiment, said plate member 20 is preferably molded from plastic. Plate 20 may be formed in many sizes depending upon the amount and type of debris being gathered by said rake assembly 10. In a preferred embodiment used primarily for gathering fallen leaves or mowed grass from a lawn, a plate 20 having a width of about 2 feet and a length of about 3 feet is typically suitable for most applications.

Teeth 24 are preferably formed integrally with plate 20; alternatively, a set of teeth 24 can be formed as a separate component and attached to forward end 21 of plate 20. In a preferred embodiment, said teeth 24 are preferably narrow, closely spaced, resiliently flexible and have tips thereof angled or curved upwardly relative to surface 22 of plate 20, in order to facilitate raking movement by said teeth 24 without snagging or gouging into a lawn, ground or other surface being raked. Although the amount of said curvature can vary, it is to be observed that said tips of said teeth 24 can be angled or curved about ½ inch relative to plate 20.

In a preferred embodiment, handle member 30 comprises a substantially cylindrical and elongate shaft member 31. Grip section 32 is disposed at one (upper) end of shaft member 31 for easy and convenient gripping of said handle member by a user. A threaded connection 33 can be disposed at the opposite (lower) end of elongate shaft member 31 from grip section 32.

Substantially U-shaped yoke member 35 can be attached to shaft member 31, such as with a threaded connection 34 that can mate with threaded connection 33 of said handle member assembly 30. Aligned apertures 37 are formed at ends 36 of yoke member 35.

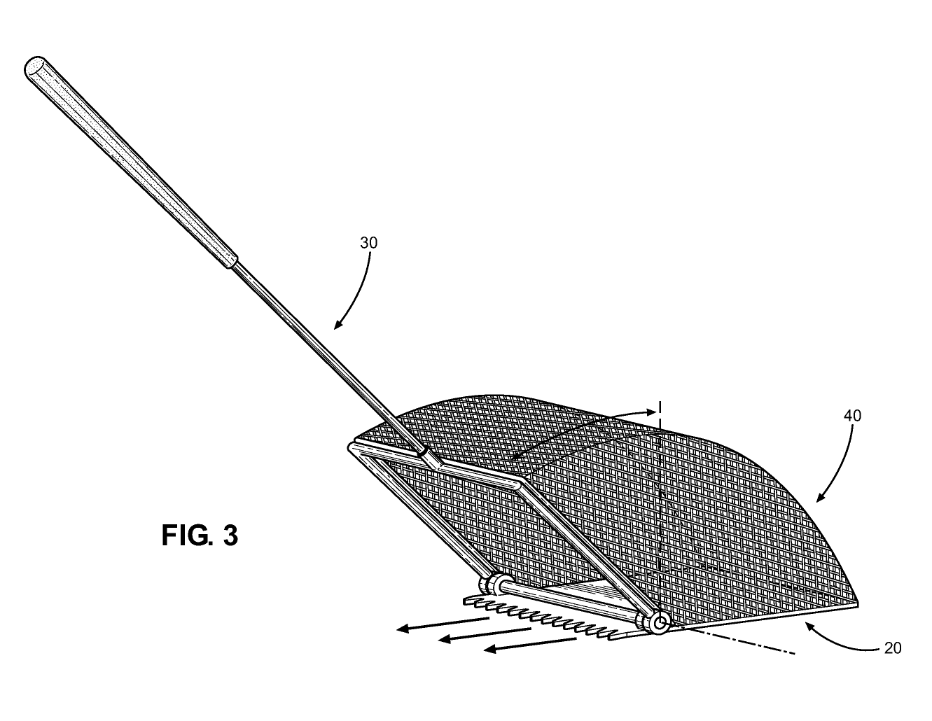

In a preferred embodiment, yoke member 35 is pivotally attached to said plate member 20. Although different attachment means can be employed, said yoke member 35 can be pivotally attached to plate 20, in the embodiment depicted in FIG. 3, said yoke member 35 is attached to lateral sides of plate 20 near forward end 21 of said plate 20. In the embodiment depicted in the appended drawings, such pivotal attachment allows yoke 35 to pivot relative to said plate member 20 about a substantially horizontal axis.

Apertures 37 at the ends of yoke member 35 are aligned and mate with apertures 25 in base plate 20. Lateral axel member 38 extends between said aligned apertures in order to pivotally attach yoke member 35 to plate member 20. Yoke member 35 cooperates with lateral axel 38 and upper surface 22 of base plate 20 to form an opening for receiving debris that is raked onto said plate member 20.

Yoke member 35 can be suitably formed of tubular material having ends 36 thereof formed with journals, or flattened with circular apertures 37 for pivotal connection to plate 20. In a preferred embodiment, elongate shaft member 31 is also suitably formed of tubular material. Shaft 31 can be fixedly attached to said yoke member 35, but is preferably adapted to be removable using a threaded connection, or other connection means, in order to facilitate manufacturing, packaging and servicing of rake assembly 10.

Flexible collection bag 40 having a front end 41 defining an opening, a rearward end 42, and a substantially rectangular bottom portion 43 that is generally positioned proximate to plate member 20. Said bottom portion 43 preferably has a width extending approximately to the sides of said plate member 20 and a length extending approximately from apertures 25 to rearward end 23 of plate 20 and can be attached to said plate 20 such that bottom portion 43 substantially covers upper surface 22 of plate 20. Alternatively, plate 20 can be sized to fit inside said bag 40, such that bottom portion 43 of bag 40 is disposed under plate 20.

Bag 40 has side portions 44 extending upwardly from bottom portion 43 and a generally rectangular top portion 45 enclosing side portions 44. Rear end 42 of bag 40 is beneficially enclosed, while front end 41 of bag 40 is secured around the opening formed by axel 38 and cooperating yoke member 35, for collecting the debris that is received through the opening.

Front end 41 of bag 40 can include a folded and hemmed opening for receiving axel 38. Said front end can also include an optional substantially rigid opening frame 47, which can be attached with snaps, bonded or otherwise attached to yoke member 35. In an alternative embodiment, side portions 44 and top portion 45 can be attached with snaps, bonded or otherwise attached directly to yoke member 35. Bag 40 can be also attached to plate 20 with snaps, bonding or a variety of well-known conventional means.

Collection bag 40 can be formed of a cloth fiber material woven in the form of heavy canvas and fabricated into a desired shape. Said bag 40 can be preferably formed of flexible plastic net woven or molded into a desired shape, and can include optional lifting handle 46 disposed at or near rearward end 42.

In operation, handle 30 can be used to push rake assembly 10, as shown in FIG. 1, or to pull rake assembly 10, as shown in FIG. 3, over a lawn or other surface to be cleaned. Rake assembly 10 is described primarily in connection with gathering and/or consolidating of cut grass, fallen leaves or other yard waste; however, it is to be observed that said rake assembly 10 can also be used to gather and collect weeds, paper, plastic trash and/or other materials or loose debris.

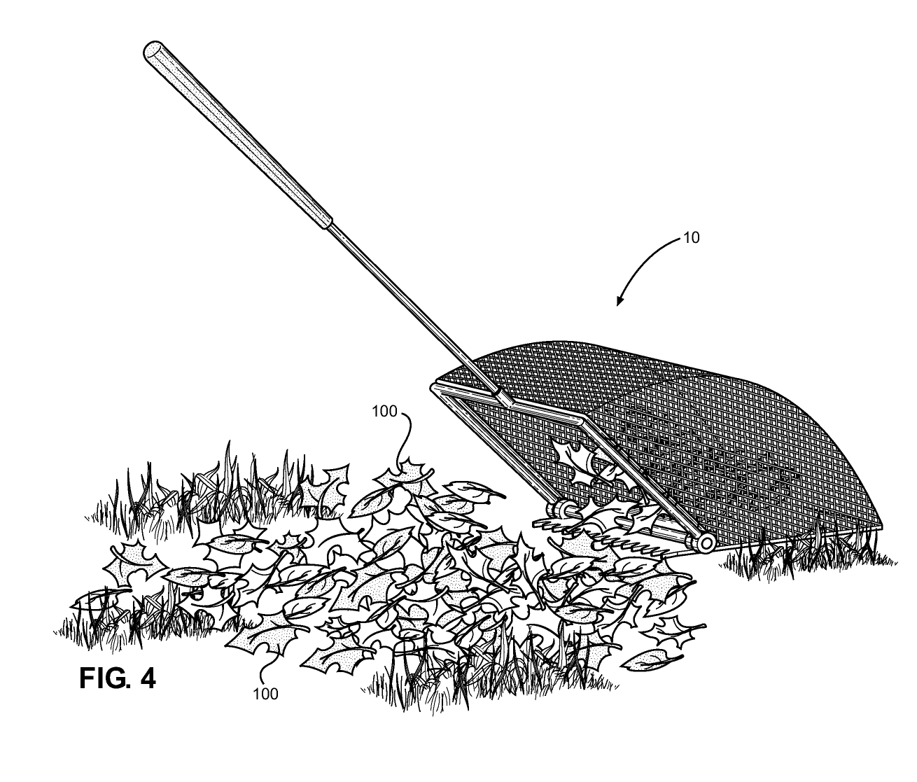

FIG. 4 depicts a perspective view of a rake assembly 10 of the present invention being used to collect leaves and/or other debris 100. Teeth 24 of plate 20 pass over said lawn and under debris 100 to rake said debris onto upper surface 22 of plate 20; as additional debris is raked onto plate 20, the initial debris is forced through the forward opening formed in collection bag 40, and progressively forced toward rearward end 42 of said bag 40. It may be necessary or helpful to occasionally pull upward on handle 30 in order to elevate and clear the opening of bag 40 to facilitate the collection of additional debris into bag 40. As plate 20 is moved in the forward direction, substantially horizontal teeth 24 act to rake and/or direct debris onto upper surface 22 of plate 20

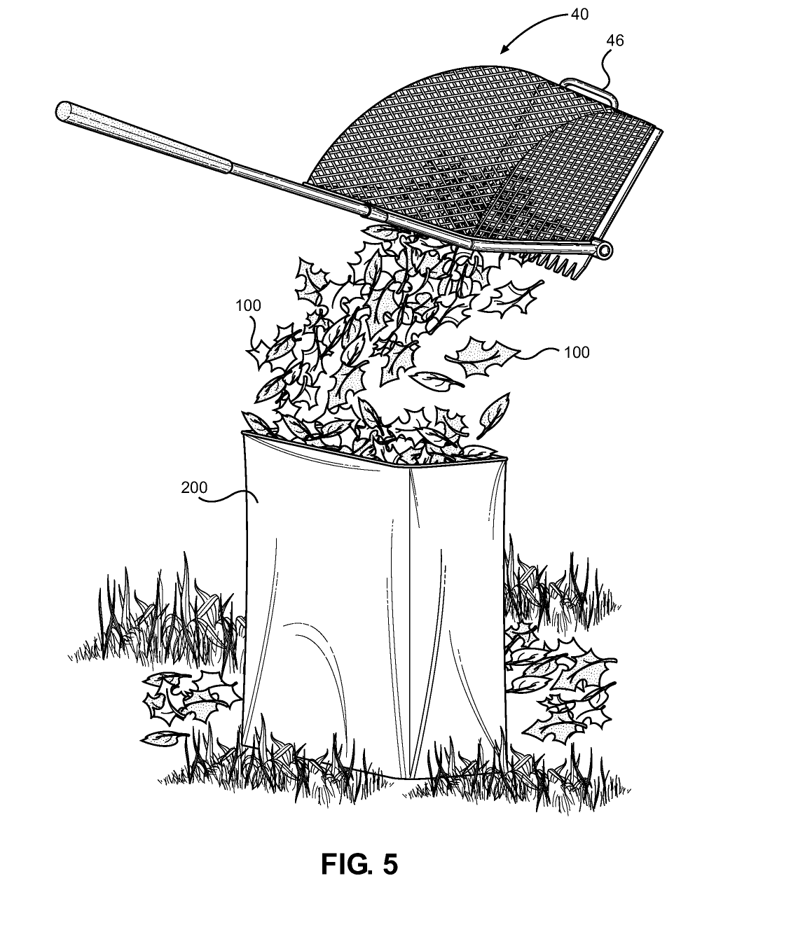

FIG. 5 depicts a perspective view of rake assembly 10 of the present invention being used to transfer leaves and/or other debris 100. When a desired amount of debris is gathered within collection bag 40 (such as when said collection bag 40 is filled with debris 100), rake assembly 10 can be carried or dragged to a desired depository, such as waste bag 200. Handle 30 is pulled upwardly to a desired height where debris 100 can be conveniently and easily emptied from bag member 40 into waste bag 200. Optional lifting handle 46 can be incorporated into the rearward end 42 of bag 40 or the rearward end of the plate 20, in order to facilitate emptying of debris 100 from collection bag 30. It is to be observed that this procedure, which beneficially does not require any bending or stooping by a user, can be repeated until a sufficient amount of unwanted debris is removed from a lawn or other surface.

The present invention provides a rake assembly with an integral debris collection bag for gathering and collecting debris, rather than directing the debris into a pile. The rake assembly of the present invention does not require an operator to bend or stoop to collect and remove debris from the lawn, for delivery to a desired depository. The rake assembly of the present invention is relatively inexpensive to manufacture, and is reliable and durable in use.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A rake assembly for collecting and removing debris from a surface comprising:
a) a yoke defining an opening;
b) an elongate shaft connected to said yoke;
c) a collection bag attached to said yoke, said bag having a front end defining an opening, a base and an enclosed rearward end, wherein said opening of said bag is substantially aligned with said opening of said yoke; and
d) a plurality of teeth.

2. The rake assembly of claim 1, further comprising a plate having a forward end, a rearward end, an upper surface, and a bottom surface, wherein said plate is disposed in proximity to said base of said bag and said teeth said extend from said forward end of said base.

3. The rake assembly of claim 2, wherein said plate is formed of a metallic material.

4. The rake assembly of claim 2, wherein said plate is formed of a plastic material.

5. The rake assembly of claim 1, wherein said collection bag is formed of a flexible woven cloth material.

6. The rake assembly of claim 1, wherein said collection bag is formed of a flexible net material.

7. The rake assembly of claim 2, wherein said yoke is pivotally attached to said plate.

8. The rake assembly of claim 8, wherein said yoke is rotatable about a substantially horizontal pivot axis.

9. The rake assembly of claim 2 further comprising a lifting handle disposed at said rearward end of said plate or said rearward end of said collection bag.

10. A rake assembly for collecting and removing debris from a surface comprising:
a) a base plate having a forward end, a rearward end, an upper surface and a bottom surface, and a plurality of teeth extending from said forward end adapted to rake debris onto the upper surface of said plate;
b) a handle;
c) a U-shaped yoke attached to said handle and pivotally attached at sides of the forward end of said plate and extending upwardly from said plate, defining an opening for receiving debris raked onto said plate,
d) an elongate shaft extending from said yoke for maneuvering said rake along said surface; and
e) a collection bag attached to said yoke, said bag having a front end defining an opening, an enclosed rear end, a substantially rectangular bottom portion positioned on the upper surface of said plate and having a width extending to the sides of said plate and a length extending substantially from the forward end to the rearward end of said plate, and having side portions extending upwardly from the bottom portion, wherein said opening of said bag is aligned with the opening of said yoke.

11. The rake assembly of claim 10, wherein said plate is formed of a metallic material.

12. The rake assembly of claim 10, wherein said plate is formed of a plastic material.

13. The rake assembly of claim 10, wherein said collecting bag is formed of a flexible woven cloth material.

14. The rake assembly of claim 10, wherein said collecting bag is formed of a flexible net material.

15. The rake assembly of claim 10, wherein said yoke is rotatable about a substantially horizontal pivot axis.

16. The rake assembly of claim 10 further comprising a lifting handle disposed at said rearward end of said plate or said rearward end of said collection bag.

17. A method of gathering and collecting debris comprising:
a) passing a rake assembly over a surface, said rake assembly comprising:
i) a yoke defining an opening;
ii) a collection bag attached to said yoke, said bag having a front end defining an opening, a base and an enclosed rearward end, wherein said opening of said bag is substantially aligned with said opening of said yoke;
iii) a plurality of teeth
b) collecting said debris within said collection bag; and
c) emptying said debris from said collection bag.

18. The method of claim 17, further comprising lifting said opening of said collection bag over a trash receptacle.
